(19) United States
(12) Patent Application Publication
(10) Pub. No.: US 2015/0038084 A1
(43) Pub. Date: Feb. 5, 2015

(54) Reduced radiation mobile phone usage via a combined wired and a wireless communication system based on roaming hot backup

(71) Applicants: Pinchas Dahan, Alfe Menashe (IL); Yehuda Amnon Singer, Tel Aviv (IL)

(72) Inventors: Pinchas Dahan, Alfe Menashe (IL); Yehuda Amnon Singer, Tel Aviv (IL)

(21) Appl. No.: 14/378,328

(22) PCT Filed: Feb. 11, 2013
(86) PCT No.: PCT/IL2013/000014

§ 371 Date: Aug. 13, 2014

(30) Foreign Application Priority Data
Feb. 16, 2012 (IL) 218159

(51) Int. Cl. H04W 36/08; H04W 4/00; H04W 40/24; H04W 36/18

(52) U.S. Cl. CPC H04W 36/08; H04W 36/18; H04W 4/008; H04W 40/24
USPC 455/41.2

(57) ABSTRACT

The present invention propose a combined communication system which integrate wired and wireless communication, based on several distributed antenna system (access points) which give rise to a significant reduced radiation. Efficient access point roaming techniques is handing over a blue tooth wireless communications session from a first access point to a second access point of distributed antenna system. The distributed antenna system is providing a communication with plurality terminal devices. The link with the more than one access points established via the terminal devices for continues the communication session.

### FIELD OF THE INVENTION

The present invention is directed to the combination of wireless and wired communication systems, and specifically is directed to a distributed antenna system with the relation to roaming techniques in a wireless communications network and in particularly relate to Blue Tooth transceiver system combined with wire lines.

### BACKGROUND OF THE INVENTION

Communication generally is based on line-phone, cordless phone, mobile devices such as smart phones, tablets, Laptops etc. To be mobile at home, one is required to carry with him the wireless cordless-phone, and the mobile devices. The connection of these devices to the outside world is via the internal WI-FI antennas located at home, or using the cellular facilities. Therefore we have the following drawbacks: 1) a home user has to carry the cordless phone and the mobile devices when moving. 2) When the WI-FI router does not cover the whole apartment, switching to the cellular internet is extremely expensive. 3) The WI-FI router, located at home, does not often cover the entire apartment or the nearly neighbourhood. The solution is to enhance the transmission power. Raising the transmission power leads to dangers caused by the increased radiation. 4) The more dangerous radiation is associated with the mobile phone which is stuck to the ear. Many researchers found that there is a relation between extensive usage of mobile communication and diseases. Many mobile phone users claim for headache and other bad feeling after extensive usage of the phone. However, since the technology is about two decades, the powerful cellular companies reject the research results by claiming for not being definitive enough.

Users that are interested in a mobile phone with a very low radiation, are using a Blue Tooth headset device. Blue Tooth is a low power radio protocol communication in a frequency of a 2.4-GHz Industrial, Scientific, Medical (ISM) band. The drawback of the Blue Tooth headset device and other Blue Tooth devices is their limited range of 30 m.

There is a desire therefore for a communication system which can be used on one hand with a very low radiation and on the other hand to use as an example the mobile phone in a desired area. In addition it is a desire to use a single mobile phone to be used as a cordless phone, a cellular phone and for a phone internet communication.

In the present invention a combination of wired and wireless communication system (hereinafter “combined communication system”) is proposed for addressing the above-discussed drawbacks and deficiencies and to provide at least the advantages described below.

The proposed “combined communication system” is based on a low-cost antenna systems (hereinafter access points APs) distributed either indoor such as at home or outdoor such as on the roof. The system is based on a fixed point unit which enables roaming to keep a continuous connection with any of the specified above devices. There is performed by overlapping in the covered areas of the distributed antennas associated with the AP. In addition, there is a data duplication (some kind of overlapping) in the APs to avoid data looses.

The proposed “combined communication system” is based also on a “wire infrastructure communication” for connecting via the APs all the mobile devices and any other permanent device to the internet, or to the Public Switching Telephone Network (PSTN), or to the cellular communication network, because each device is inspected by at least one AP. When the low radiation APs, are spread in a neighbourhood environment with overlapping areas between the APs, it forms a network which enables every mobile device to transfer data continuously over the internet. In addition to the spread APs, each mobile device has a pre-installed software which communicates with the APs to manage the information stream without data loses.

### THE DRAWINGS

FIG. 1-a: A combination of wireless and wired communication systems.

FIG. 1-b: Street Topology.

FIG. 2: Access pints connection to any “communication network service”.

FIG. 3: Access Point configuration connected to a PSTN network.

FIG. 4: Access Point configuration connected to a TV cable network.

FIG. 5: Access Point configuration connected to a PSTN and a cellular network.

FIG. 6: Communication between two phones using roaming process.

FIG. 7: State machine in an AP for Message Handling: BT Roaming

FIG. 8: State Machine: Master AP interfacing Network Services.

### THE INVENTION

In this invention several embodiments are described and are accompanied by drawings presented in the following description. But some other embodiments might be utilized by structural and functional modification which is still in the scope of the present invention.

The present invention proposes a solution reling on the wired infrastructure such as phone line and internet cables routed in whole of the civilized areas. The solution is based on a low-cost antenna systems (hereinafter Access Points APs) distributed either indoor such as at home or outdoor such as on the roof. These APs are interfacing the mobile phones via the Blue-Tooth standard, and interface the internet network using IP protocol. The term AP as used herein refers to a device equipped with a BT module which is adapted to deliver information to other APs and to various communication system such as internet, cable TV etc. The BT protocol in the AP enables to communicate with several Blue Tooth devices identified on device addresses. Thus the distributed APs which are communicates in Blue-Tooth on one hand and are connected to the “communication network service” overcome the limited area range covered by the single BT antenna. The term “communication network service” as used herein refers to various kind of communication network such as: internet communication network, a PSTN communication network, a cellular communication network and other communication network. According to one aspect of the present invention the “combined communication system” is providing a method of extending the area covered by BT communication method and to enable users to move in unlimited indoor range and to keep continuous communication between the users to the “communication network service”.

According to another aspect of the present invention the “combined communication system” is providing a method of extending the area covered by BT communication method and to enable users to move in unlimited outdoor range and to keep continuous communication between the users to the “communication network service”.

According to another aspect of the present invention to provides to the users a plurality of communication with a significant reduced radiation. As an example the mobile phone is used with a SAR reduction up to three order of magnitude compare to the conventional mobile phone communication while keeping continuous communication in an extended range beyond the typical Blue Tooth range.

According to another aspect of the present invention is to provides the users to carry a single mobile phone to be used as a cordless phone and as a cellular phone, and for access the internet and to send receive video and voice either from a smart phone. The system is supporting devices such as: a smart phone, a camera, a video camera, a Laptop, a Tablet etc.

According to another aspect of the present invention is to provide a mode of operation guarantees continuous communication and also avoiding of loosing data during roaming from one AP to another.

According to another aspect of the present invention is to provide a mode of operation guarantees continuous communication and also avoiding of loosing data due to a failure of connection with the “communication network service”.

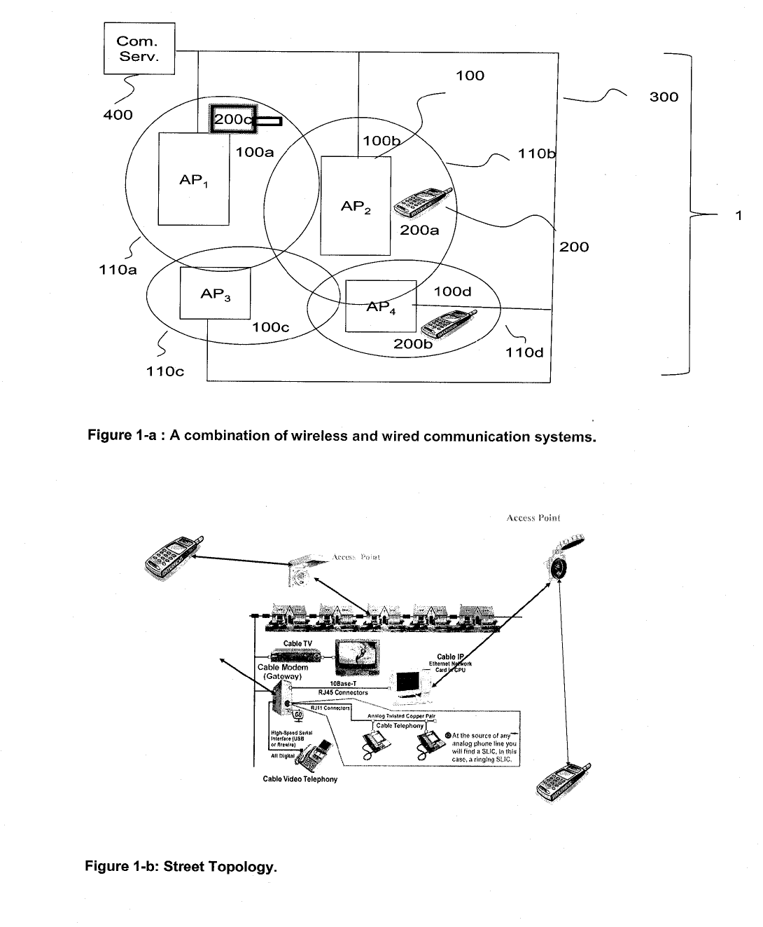

FIG. 1 shows the embodiments of the present invention which are based on the combination of wireless and wired communication systems 1 and are supporting a very low radiation mobile communication. The “service area” in the present invention is denoting an indoor service area or an outdoor service area. The indoor service area might be home, office or a building. The outdoor service area may be a street, campus (hospitals, universities), roads, and all the environment area between roads. The service area, FIG. 1-a, in the present invention is divided into number of cells covered by the transceiver system called access point, AP 100. The transceiver access points AP₁, AP₂, AP₃ and AP₄ are respectively denoted by 100a, 100b, 100c and 100d. Each AP has a corresponding coverage area, 110a, 110b, 110c and 110d. Several of these area associated with the APs are overlap as an example 110a is overlap with 110b and 110c. For some of the communications applications, the terminal devices 200a, 200b are portable and may move from one coverage area to second coverage area during the communication session without any disconnection or a loss of data.

The system is composed of Access Points (APs) which are connected to various kinds of line based networks such as a twisted pair copper wires, a PSTN cable, an internet cable, a TV cable, a coaxial cable and any of their combination which will be denoted in the present invention as a “wire infrastructure communication” 300. Using the “wire infrastructure communication” 300 the data are delivered by various kind of communication network such as: internet communication network, a PSTN communication network, a cellular communication network and other communication network which are denoted in the present invention as a “communication network service” 400.

The APs are having a “cloud” of Blue-Tooth (BT) area denoted by 110a, 110b, 110c, 110d etc. Each AP has its own cloud. However, every cloud has at least two overlapping clouds. Hence, a mobile devices having a BT, can observe that it is connected either with at one cloud associated with an AP or at least two clouds associated with different APs. The system provides coverage communication for mobile subscriber as an example unit 200a and 200b and for fixed subscriber unit 200c such as: a camera, a microphone, a dial telephone and various kindsof sensors which are denoted in the present invention as a “means device for sending and receiving signals” 200c. This ensures continuous communication by enabling roaming. Each mobile device 200a, 200b, 200c, has a unique fixed IP number or equivalent. The AP is a sort of a concentrator having a fixed IP address, or alternatively, the IP address may be dynamic. System 1 is capable of 1) simultaneously distributing data between the terminal devices 200a and 200b to the “communication network service” 400, and 2) avoid data looses by data redundancy: sending the data to AP having the same overlapping coverage areas.

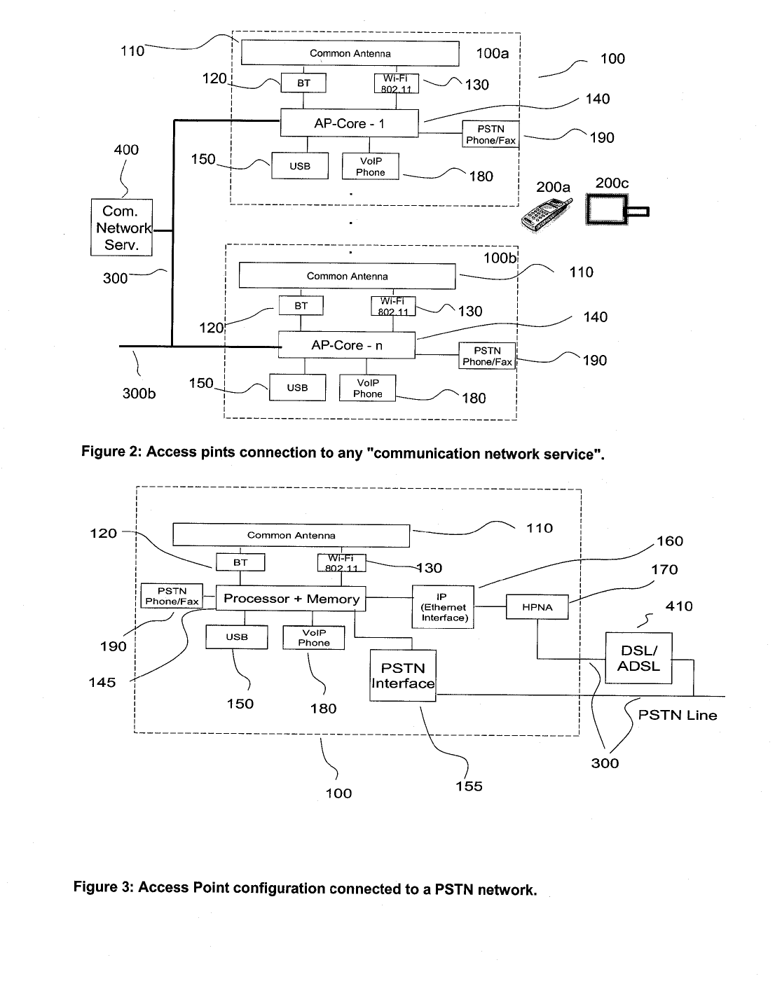

FIG. 2 shows architecture of one possible implementation of system 1 in some embodiments where the APs 100 are connected via “wire infrastructure communication” 300 and is combined with any “communication network service” 400 and the devices supported by the APs are connected both to the 300 and the BT communication system 130 via the antenna 110. As an example the supported devices are: mobile phones and tablets 200a via the BT interface, line based PSTN devices 190 such as regular phone, FAX and other secretary devices, line based IP phones 180, line based laptops and tablets, cameras via the IP 180, or the USB 150. The whole APs are connected by the 300. The AP core unit 140 is routing the IP data through the “communication network service” 400, while regular phones, faxes and other secretary devices are routed by 140 to the PSTN line 300b. Additional devices 200c like smart/security cameras, phone including cameras, can be connected to the network as mobile devices using all the specified above interfaces.

FIG. 3 shows a configuration of the APs 100 for implementing system 1 as an example of another embodiment. In this embodiment the APs 100 are connected via “wire infrastructure communication” 300 based on the PSTN line and a DSL/ADSL modem. The AP is a sort of a concentrator having a fixed IP address, or alternatively, the IP address may be dynamic. The data from BT 120 or Wi-Fi 130 are accepted from either a mobile phone or a Laptop/PC/Tablet and are routed, by the processor unit 145 in the AP-core 140, to IP Ethernet interface 160 and then to the HPNA adapter unit 170. The HPNA adapter unit 170 enables connecting several ADSL devices to the same PSTN line 300 which include a single ADSL modem router 410. The same applies to data accepted from the regular internet or ADSL line which may be routed back to these devices. In addition, a mobile phone/Laptop/PC/Tablet can also interface a regular PSTN line 155 acting as a conventional Pulse/Tone device. The processor unit 145 and its memory include software which manages and routes from its data source to the destination of all the interfaces 155 and 160 and vice versa. Data management include “hot backup” feature.

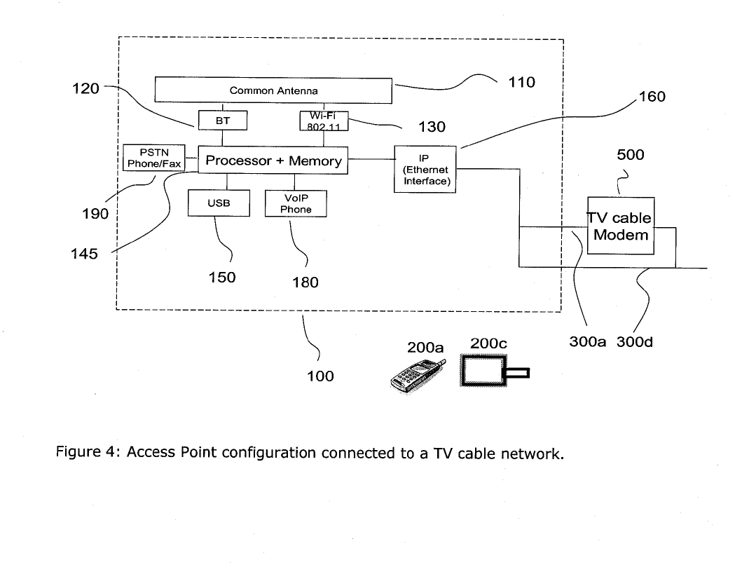

FIG. 4 shows a configuration of the APs 100 for implementing system 1 as an example of another embodiment. In this embodiment the APs 100 are connected via “wire infrastructure communication” 300 based on a TV cable connected to TV modem 500. The mobile phones and Tablets 200a are communicate via the BT interface. The devices line based PSTN such as a regular phone, a FAX, secretary devices are connected through 190. The devices line based IP phones are connected through 180. The devices line based Laptops and Tablets, cameras are connected via the IP 180, or the USB 150. The whole APs are connected by the PSTN compatible lines 300d. The IP data are routed, by the processor unit 145 in the AP-core 140, through the TV cable 300 to the TV modem 500, while regular phones/faxes and secretary devices are connected to the PSTN line 300b located on the AP. Additional devices 200c like smart/security cameras, phone including cameras, can be connected to the network as mobile devices using all the specified above interfaces.

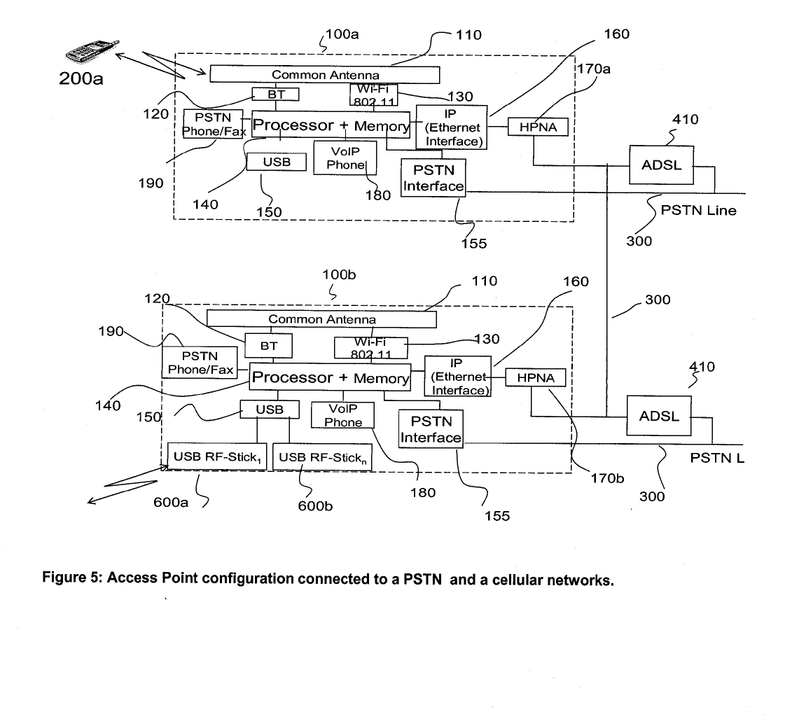

FIG. 5 shows a configuration of another embodiment for implementing system 1 which capable to establish a connection via cellular network communication located in AP 100b while the mobile devices 200a are located in the area covered by AP 100a and are communicating via low radiation BT communication 120. Other communication can be establish simultaneously as an example the regular PSTN communication 190 or IP communication 180. In this configuration, several AP interfaces USB RF Stick 600a, 600b are connected to the USB connections 150. These sticks replace mobile phone RF interfaces to manage communication. Each USB RF stick is associated with one cellular/mobile phone. When the mobile phone is connected to the system, the RF circuitry of the mobile phone does not work. Instead, the mobile phone communicates as described in the sequel (following FIG. 5).

The mobile phone is connected via the antenna 110 associated with the BT 120 of AP 100a. The communication is then routed to the Ethernet interface 130, HPNA 170 of AP 100a to the ADSL 300. The ADSL 300 communicates with the AP 100b which has the RF sticks: ADSL 300 connected to AP 100b communicates with the ADSL 300 connected with AP 100a. The communication is routed to the HPNA 170 to the Ethernet Interface 130 to the USB 150 of AP 100b. These USBs are connected to the RF sticks 600 which is a pure cellular communication.

It may come that in a site where several APs are used, only one AP has these USB-RF sticks. In FIG. 5, the AP 100b will route the cellular communication to AP 100a using logical Ethernet protocol on ADSL/Cable TV etc 300.

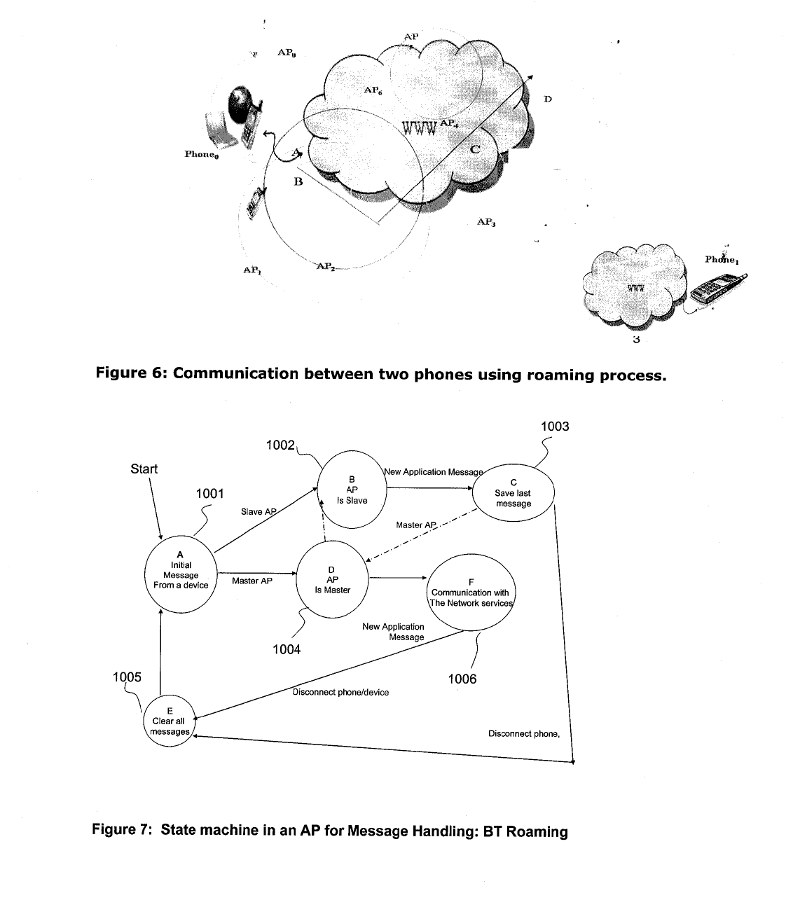

FIG. 6 shows the communication using roaming of the present invention. Phone₀ is moving while phone₁ may be located in a different area. Phone₀ is establishing a link with the first AP via BT communication. When Phone₀ is moving to an area covered with at least two APs, the roaming process is starting automatically. In that case of active roaming process, each phone has to be connected to at least two Blue-Tooth antennas connected to two different APs. One AP is considered as a Master (Master AP), while other APs are considered as Slaves (Slave AP). Slave APs serve as a hot backup when the Master AP looses connection with the mobile device. For example in FIG. 6, Phone₀ started in covered area AP₀. During its moving to point A where there is an overlapping area of AP₀, AP₁, and AP₂, AP₀ is a master while AP₁ and AP₂ are considered as slaves. The roaming process means that for a trajectory via A,B,C,D at point A, AP₀ is the master while AP₁, AP₂ are the slaves. AP₄ and AP₅ do not have any connection with the phone. At point B, AP₀ looses connection with the phone Phone₀, and then AP₁ becomes a Master and AP₂, is the slave. At point C, AP₃ becomes a Master and AP₄, is the slave.

Every phone has two addresses: 1) An address associated with the BT interface. This address is changing dynamically when the phone is moved, and 2) An IP address which remains fixed. Consider again FIG. 6. A phone is moving. The phone is connected with AP₀, AP₁, AP₂, and AP₃ which give him the BT addresses: BT (AP₀, BT(AP₁) etc. The phone has a fixed IP address. Upon receiving the same message by AP₀, AP₁, AP₂ with the destination of the phone, the Master AP sends the message via the BT interface. If AP₀ is the master, it sends the message to the phone using the BT (AP₀) address. When AP₀ looses connection, AP₁ becomes a Master and sends the message to the same phone using the BT(AP₁) address.

We present here the roaming algorithm which for example connects two long distance mobile devices (see FIG. 6): Phone₀ and Phone₁. We assume: 1) Phone₁ is elsewhere, and 2) Phone₀ is moving along the trajectory: A,B,C,Dl. The configuration establishes a continuous connection without lost of data between the two phones. The APs and the mobile devices have an IP address. The communication protocol is given in the following table:

| Point in the | Master | Slave | Message sent to Phone₁ | Response of Master AP associated |
|---|---|---|---|---|
| trajectory | AP | APs | via Master AP. | with Phone₁ |
| A | AP₀ | AP₁ | The message reports on | The Master AP associated Phone₁ |
| | | | AP₀ Master and AP₁ is a | sends a message reporting on |
| | | | Slave AP. | Master and Slaves APs. |
| | | | Sends application messages | 1. Sends application messages |
| | | | to Phone₁ via AP₀. | to Phone_{0.} |
| | | | 1. Sends an acknowledge | 2. Acknowledges messages sent |
| | | | message to Phone₁. | by Phone_{0.} |
| | | | 2. Sends AP_{1,} to ignore | |
| | | | and delete the message | |
| | | | received from Phone_{1.} | |
| | | | 3. Sends application | |
| | | | messages to Phone₁. | |
| B | AP₁ | AP_{2,} | The message reports on | Phone₁ sends a message reporting |
| | | | AP₁ Master and AP_{2,} as a | on Master and Slaves APs. |
| | | | Slave AP. | |
| | | | 1. Sends an | Continues to the next messages. |
| | | | acknowledge message to | |
| | | | Phone₁. | |
| | | | 2. Sends AP_{2,} to | |
| | | | ignore and delete the | |
| | | | message received from | |
| | | | Phone₁. | |
| C | AP₃ | AP₄ | The message reports on | |
| | | | AP₃ Master and AP_{4,} as a | |
| | | | Slave APs. | |
| | | | 3. Sends an | |
| | | | acknowledge message to | |
| | | | Phone₁. | |
| | | | Sends AP_{1,} AP₂ to ignore | |
| | | | and delete the message | |
| | | | received from Phone_{1.} | |

FIG. 7 shows a roaming architecture of another possible embodiment for implementation of communication system 1 to enable “hot/dynamic backup”. In this implementation each device sends messages to several APs. At least one AP has to response. In overlapping areas in which several APs give response, the BT selects one AP as a Master AP, while the others are considered as Slave APs. This mode of operation guarantees continuous communication and also avoiding of loosing data during roaming from one AP to another.

FIG. 7 shows a diagram of a state sequences of each AP to avoid a lost of data during a handover process due to the Blue Tooth roaming. In the figure each circle represents a state. The arrows entering each state, represent the input, which can be accepted by the AP when it is in that state. For example, at state A 1001, each AP receives a message stating it as a Master, State B 1002 or a Slave, State D 1004. A Slave AP at state B 1002, which accepts a message, moves to State C 1003, stores the message until being informed to delete it. The AP continues to be in State C managing the messages in a FIFO. A master AP at state D 1004 moves to state F 1006, and transfers the message to its destination via the selected network services. In that state, the Master AP will receive messages from the remote device/phone via the “communication network service” and it will transfer it to the local device/phone. A Slave AP also gets the messages from “communication network service” and keeps them until directed to delete them.

FIG. 7 shows a Blue-Tooth roaming: A Master AP is disconnected due to moving of the local device/phone, while a Slave AP is informed to be a Master AP. In that case, the Slave AP being at state C 1003 is moving to be state D 1004, a Master AP. The AP which was a Master AP at state D 1004, dashed arrow, is either disconnected while moving to state E 1005, or becomes a Slave AP being at state C 1003.

In addition, a Master AP and a Slave AP can be inter switched due to received signal strength.

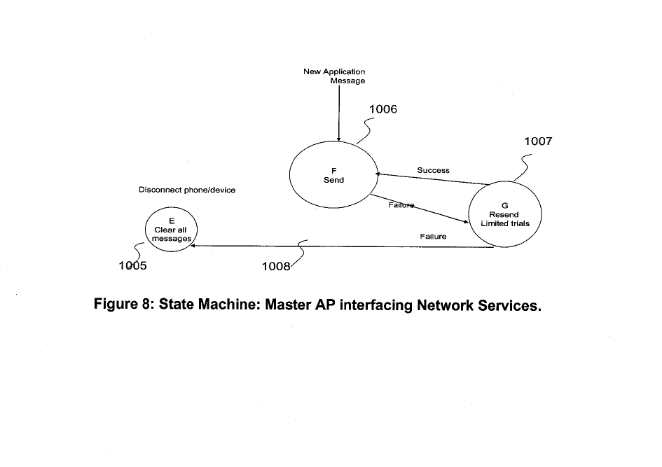

FIG. 8 shows a roaming architecture of another possible embodiment for implementation of system 1 to enable “hot/dynamic backup” for the case of failure connection with the “communication network service”. This figure is an extension to FIG. 7 which shows the case in which a Master AP being at state F 1006 gets application messages which it directs to the “communication network service”. Whenever a failure is occurred with the “communication network service”, then the AP enters to state G 1007 in which it performs several retires to transfer the message. If the retries end in success, then the AP returns to state F 1006 and the AP remains as master. In a case, when failure to access the “communication network service” exists, then the AP disconnects the local phone, state E 1005. The mobile device/phone transfers one of its Slave AP to become a master as in FIG. 7.

1. A combination of a wireless and wired communication system, communicating with wires/wireless communications data, from and to terminal devices, in particular by a short range communication system such as Bluetooth communication, comprising:
a) One or more Bluetooth-enabled terminal devices such as a mobile phone;
b) a Bluetooth-enabled access point comprising: a short range transceiver such as Bluetooth system, communicating with one or more Bluetooth-enabled terminal devices, means for sending and receiving signals over a “communication network service”, means for initiating communication over selected communication network links from the “communication network service”, wherein the access point is routing a respective mobile phone device to each respective one of said plurality of separate “communication network services”, in response to identification of a required “communication network service”;
wherein each Bluetooth-enabled terminal device is enabled to communicate through the access point over the “ communication network service”;

2. A combination of a wireless and wired communication system, communicating with wires/wireless communications data, from and to terminal devices, in particular by a short range communication system such as Bluetooth communication, comprising:
a) One or more Bluetooth-enabled terminal devices such as a mobile phone;
two or more Bluetooth-enabled access points where each access point comprising: a short range transceiver such as Bluetooth system, communicating with one or more Bluetooth-enabled terminal devices, means for sending and receiving signals over a “network communication service”, means for initiating communication over selected communication network links from the “communication network service”, pairing each access point with at least another one access point, wherein at least one of the access point is operatively coupled to the “network communication service”, wherein each access point connects to the “communication network service” through an access point that has the connection to the “communication network service” and each access point is routing a respective mobile phone device to each respective one of said plurality of separate “communication network services”, in response to identification of a required “communication network service”;
wherein each Bluetooth-enabled terminal device is enabled to communicate through each access point over the “network communication service”;

3. A combination of a wireless and wired communication system, communicating with wires/wireless communications data, from and to terminal devices, in particular by a short range communication system such as Bluetooth communication, comprising:
b) One or more Bluetooth-enabled terminal devices such as a mobile phone;)
c) two or more Bluetooth-enabled access points where each access point comprising: a short range transceiver such as Bluetooth system, communicating with one or more Bluetooth-enabled terminal devices, means for sending and receiving signals over a “network communication service”, means for initiating communication over selected communication network links from the “communication network service”, pairing each access point with at least another one access point through wire communication, wherein at least one of the access point is operatively coupled to the “network communication service”, wherein each access point connects to the “communication network service” through an access point that has the connection to the “communication network service” and each access point is routing a respective mobile phone device to each respective one of said plurality of separate “communication network services”, in response to identification of a required “communication network service”;
wherein each Bluetooth-enabled terminal device is enabled to communicate through each access point over the “network communication service”;

4. The combined communications system according to claim 3, further comprising:)
a) roaming management system communicating mobile device with at least one of the distributed access points and establishing a link with the second access point;
wherein each Bluetooth-enabled terminal device is enabled to communicate through the access point over the “network communication service”.

5. The combined communications system according to claim 4, wherein the roaming management system is incorporated within the mobile device and the access points comprising; an IP address.

6. The mobile device with a roaming management, at the application data level system according to claim 5, comprising;
a. the established link with the first AP by short range radio communication such as Blue tooth communication;
b. identify when the mobile device is covered with at least two APs, and starting the roaming process automatically;
c. determine the master AP and the hot backup slave AP and authenticating their IP address;
d. identify loosing connection with the master AP and determine the slave AP as master AP and continuing the communications session with the second access point using the standard address of the second access point;
e. avoiding loosing data when a Master AP is disconnected.

7. The mobile device with a roaming management system according to claim 6, wherein the alternative access point address is selected by the mobile device during of the first access point connection, by transmitting a search signal for the second access point for establishing the alternative access point address.

8. The mobile device according to claim 7, with a roaming management, at the application data level system that is capable of handing over a blue tooth communications session from a first access point to a second access point, and continuing the communications session with the second access point using the address of the second access point.

9. The combined communication system according to claims 8, has multiple copies of the same data in the access points as a “hot-backup”, when an AP looses connection with a mobile device another AP can manage the data communication with the mobile device; if the mobile device sends data, the AP which becomes a master, sends the data to the destination; if the mobile device receives data from one AP and that associated AP looses connection with the mobile device, than the new AP which becomes a master sends the data to the mobile device automatically.

10. The combined communication system according to claims 8, has multiple copies of the same data in the access points as a “hot-backup”, when an AP looses connection with a “communication network service” another AP can manage the data communication with the “communication network service”; if the mobile device sends data, the AP which becomes a master, sends the data to the destination; if the mobile device receives data from one AP and that associated AP looses connection with the “communication network service”, than the new AP which becomes a master sends the data to the “communication network service” automatically.

11. The combined communication system according to claims 9, wherein the roaming management is implemented to enable mobile communication in the street, small villages, campuses and road environments.
